(19) United States
(12) Patent Application Publication
(10) Pub. No.: US 2003/0054929 A1
(43) Pub. Date: Mar. 20, 2003

(54) Flat bottom, stand up bag and method of manufacturing the same

(76) Inventors: William E. Post, Canton, OH (US); Larry L. Lanham, Canton, OH (US)

Correspondence Address: SAND & SEBOLT, 4801 DRESSLER RD., N.W., SUITE 194, CANTON, OH, 44718, US

(21) Appl. No.: 10/246,152

(22) Filed: Sep. 18, 2002

Related U.S. Application Data
(60) Provisional application No. 60/323,588, filed on Sep. 19, 2001.

(51) Int. Cl. B31B 1/90

(52) U.S. Cl. 493/218

(57) ABSTRACT

A stand up bag having a flat bottom is formed from a weldable material. The bag includes a seam that closes the bag's bottom wall. The seam is welded flat so that the bag is free of protruding elements. A method for manufacturing the bag includes the step of overlapping the leading edge of a tube and welding the overlapped edge to form the flat, welded seam that allows the bag stand on end in an open condition. The apparatus for manufacturing the bag includes a former that may be moved between retracted and expanded positions with an actuator. The former holds the lower portion of the bag in an expanded position while clamp plates form the overlap seam. A bottom welder is used to weld the overlap seam while the clamp plates hold the bottom of the bag against a portion of the former.

### CROSS REFERENCE TO RELATED APPLICATIONS

This application claims priority from United States Provisional Patent Application serial No. 60/323,588 filed Sep. 19, 2001; the disclosures of which are incorporated herein by reference.

### BACKGROUND OF THE INVENTION

1. Technical Field

The present invention generally relates to storage containers in the field of flexible bags and, more particularly, to stand-up bags that may be folded flat and that have a flat bottom when unfolded to support the bag in a stand-up position. Specifically, the present invention relates to flat-bottom, stand-up bags that are fabricated from a polymer material wherein the seams of the bag are welded in a manner that yields a flat seam on the bottom surface of the bag.

2. Background Information

Stand-up bags are used in a wide variety of applications. One of the most common uses for stand-up bags is to hold food at a fast food retail establishment. Stand-up bags provide a relatively inexpensive package to deliver multiple items of food and drink to a customer who may be standing at a counter inside the retail establishment or who may be sitting in a vehicle at a drive-up window. Some fast food establishments may use multiple people to fill an order that is placed in a single bag. In this situation, the clerk who receives the order may fill the drink order for while allowing other employees to fill the food portion of the order. While the customer waits for the order to be filled, the bag may be standing on the counter or at a station behind the counter where orders are filled. Bags that stand up in an open configuration allow the workers to view the contents of the bag and insert items into the bag without repeatedly handling the bag and disturbing the contents of the bag. Stand-up bags that remain in the open configuration also have the advantage that they are easier to fill with the various order items by store employees. Stand-up bags also have the advantage that consumers can place them in their vehicles and on tables without upsetting the contents of the bags.

The most common type of a stand-up bag is fabricated from a paper material. Although paper may be coated with a substance, such as wax or a polymer, that will resist liquid spills and grease absorption, a large liquid spill will destroy the integrity of the bag causing the bag to fail. The art thus desires a stand-up bag that may be fabricated from a polymer material that is substantially resistant to moisture absorption.

Some polymer bags include a flange that extends from the bottom surface of the bag that prevents the bags from standing upright. In some paper bags, a separate patch is used on the bottom of the bag to cause the bag bottom to be flat and to increase the strength of the bag. The art thus desires a polymer stand-up bag that has a flat bottom free of extending flanges and patches. Such a bag must be able to be efficiently manufactured from a variety of materials.

### BRIEF SUMMARY OF THE INVENTION

The invention provides a stand up bag having a flat bottom that is formed from a material that may be welded. The bag includes a seam that closes the bottom wall of the bag. The seam is welded flat so that the bag is free of protruding elements that would prevent the bag from standing in an upright position.

The invention also provides a method for manufacturing a bag having a flat bottom with no protruding seam. The bottom of the tube that forms the sidewall of the bag is folded into the bottom wall of the bag with the leading edge of the tube being overlapped and welded to form the flat, welded seam that allows the bag to stand on end in an open condition.

The invention also provides an apparatus capable of manufacturing a bag having a flat bottom with no protruding seam. The apparatus includes a former that may be moved between retracted and expanded positions with an actuator. The former holds the lower portion of the bag in an expanded position while clamp plates form the overlap seam. A bottom welder is used to weld the overlap seam while the clamp plates hold the bottom of the bag against a portion of the former.

### BRIEF DESCRIPTION OF THE SEVERAL VIEWS OF THE DRAWINGS

FIG. 1 is a perspective view of the first embodiment of the bag of the present invention.

FIG. 2 is a front view of the bag of FIG. 1.

FIG. 3 is a side view of the bag of FIG. 1.

FIG. 4 is a bottom view of the bag of FIG. 1.

FIG. 5 is an enlarged view of one portion of the bottom of the bag.

FIG. 6 is a perspective view of the second embodiment of the bag of the present invention.

FIG. 7 is a front view of the bag of FIG. 6.

FIG. 8 is a side view of the bag of FIG. 6.

FIG. 9 is a bottom view of the bag of FIG. 6.

FIG. 10 is an enlarged view of one portion of the bottom of the bag.

FIG. 11 is a schematic side view of the first step in the process for making the bags of FIGS. 1 and 6.

FIG. 12 is a view similar to FIG. 11 showing the second step of the process.

FIG. 13 is a view similar to FIG. 11 showing the third step of the process.

FIG. 14 is a view similar to FIG. 11 showing the fourth step of the process.

FIG. 15 is a view similar to FIG. 11 showing the fifth step of the process.

FIG. 16 is an enlarged view of the overlap and clamp plate.

FIG. 17 is an enlarged view of the bottom welded.

FIG. 18 is an enlarged view of the bottom former.

Similar numbers refer to similar parts throughout the specification.

### DETAILED DESCRIPTION OF THE INVENTION

A first embodiment of the flat bottom, stand up bag according to the present invention is indicated generally by the numeral 10 in the accompanying drawings. Bag 10 includes a continuous sidewall 12 and a bottom wall 14 that cooperate to define a storage compartment for holding items. Bag 10 may have any of a variety of shapes such as the exemplary rectangular shape shown in the drawings. In other embodiments, the cross section of bag 10 may be square, triangular, oval, or round. In the exemplary rectangular embodiment, sidewall 12 of bag 10 includes opposed substantially flat front and back walls with opposed gusseted sidewalls. These walls are joined at corners formed by folding or creasing the material that forms sidewall 12.

Bag 10 may be fabricated from essentially any material that may be welded. Such materials generally include a large number of plastic and metal materials that are known in the art of flexible packaging. Exemplary materials include mono layer and co-extrusion blown films, laminates, multi-layered materials, and foils.

Sidewall 12 includes first 16 and second 18 longitudinal edges that are joined together in an overlap seam 20 to form continuous sidewall 12 in the shape of a tube that forms the majority of bag 10. In the first embodiment of the invention, seam 20 is centrally positioned with respect to one of the walls of bag 10. In the exemplary rectangular embodiment, seam 20 is disposed in the center of one of the wide walls as depicted in FIG. 2. In other embodiments of the invention, seam 20 may be offset with respect to center if such offset is desired.

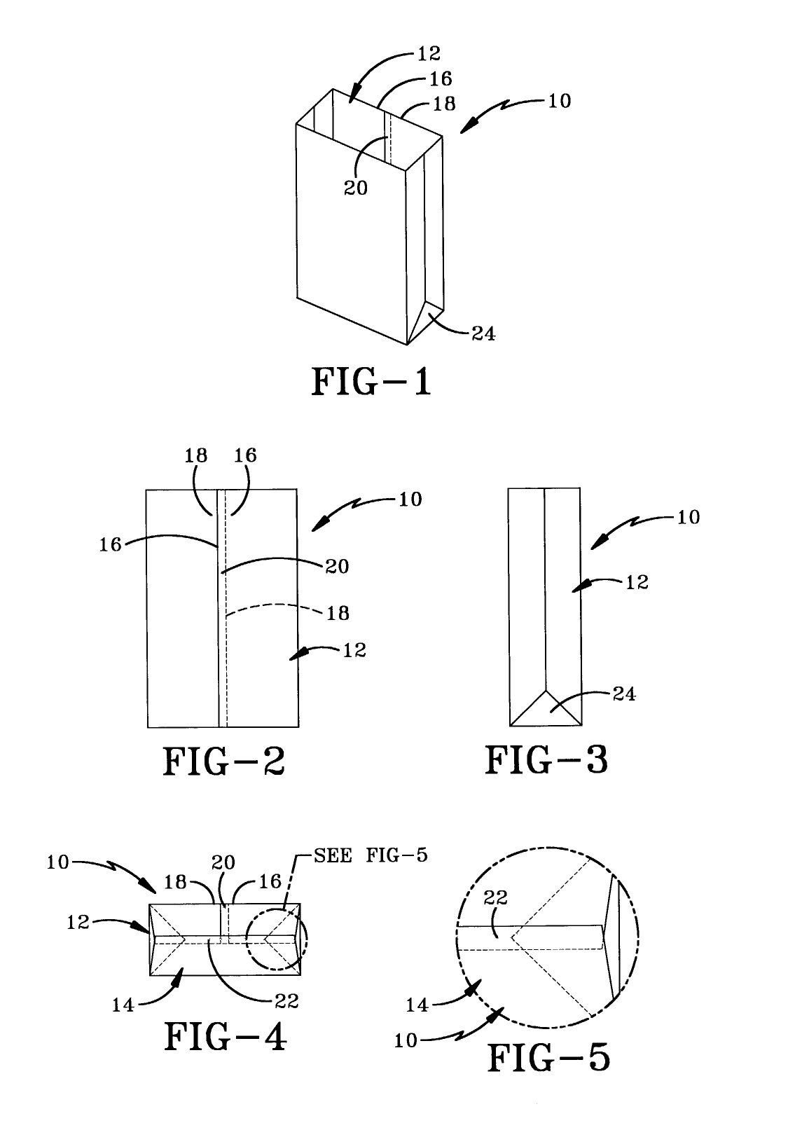

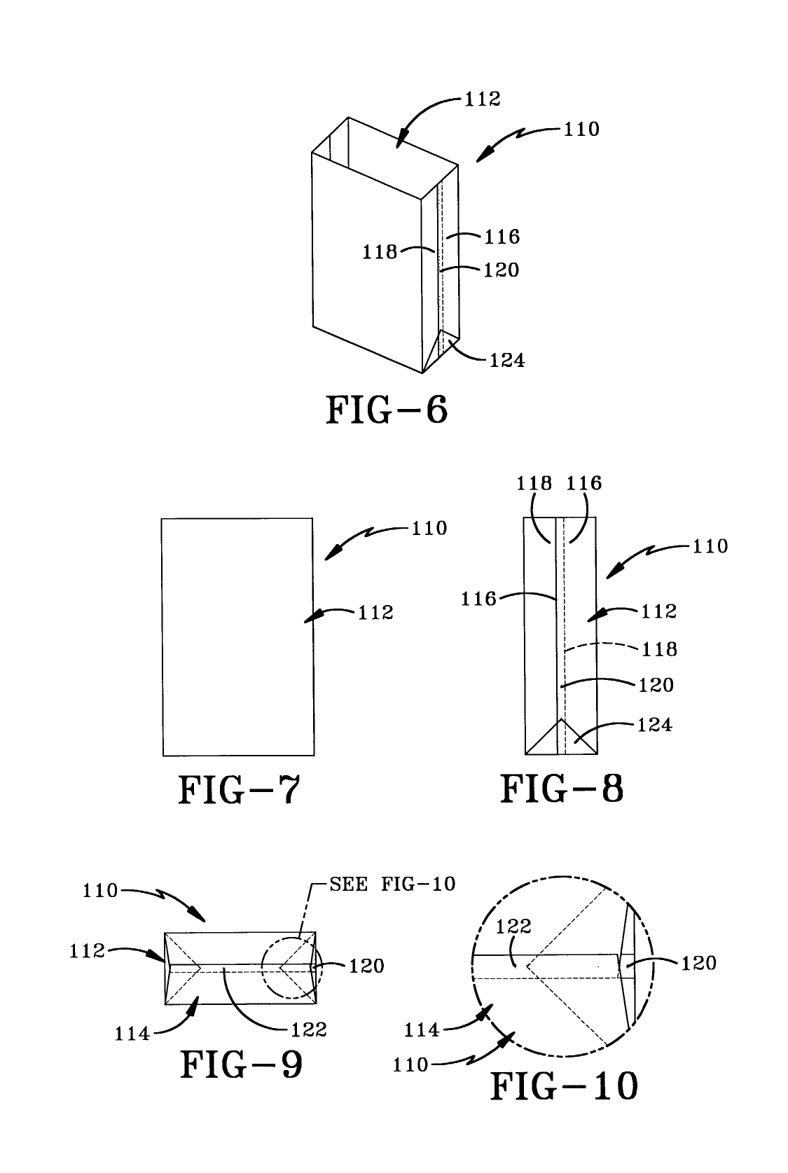

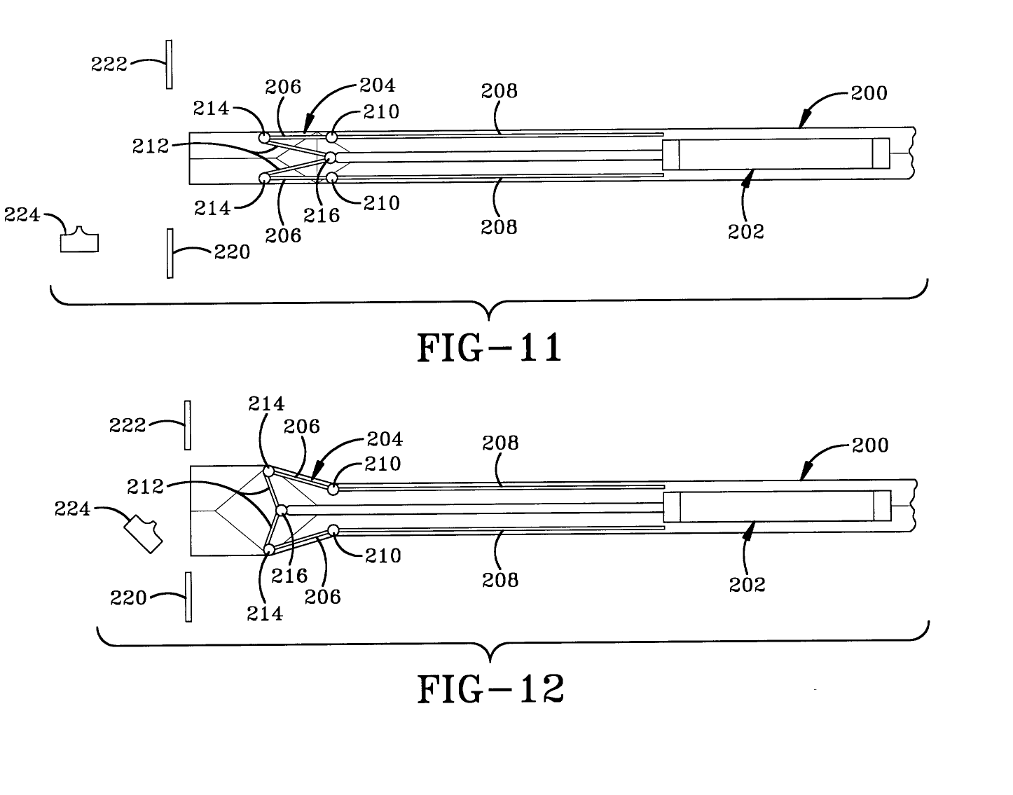

Bottom wall 14 is formed from the same tube of material that is used to form sidewall 12. This tube is folded to form bottom wall 14 with the ends of the tube being overlapped and welded onto themselves to form a flat seam 22 such that wall 14 is free of a projecting seam. The folding process creates gussets 24 that allow bag 10 to be folded flat. The configuration of these gussets and the general manner of folding them is known to those skilled in the art and the specific folds are not described in detail in this specification. When bottom wall 14 is folded, seam 20 extends across half of bottom wall 14. Bottom wall 14 is thus flat and allows bag 10 to stand up in an open configuration as depicted in FIG. 1 so that bag 10 may be used in the manners described in the Background of the Invention section of this specification. In known prior art bags, the end of the tube used to form the bag would form a projecting flap when the edges of the tube are welded together. Such a projecting flap would hinder the bag from standing upright. The invention overcomes this drawback in prior art bags.

A second embodiment of the flat bottom, stand up bag according to the present invention is indicated generally by the numeral 110 in the accompanying drawings. Bag 110 includes a continuous sidewall 112 and a bottom wall 114 that cooperate to define a storage compartment for holding items. Bag 110 may have any of a variety of shapes such as the exemplary rectangular shape shown in the drawings. In other embodiments, the cross section of bag 110 may be square, triangular, oval, or round. In the exemplary rectangular embodiment, sidewall 112 of bag 110 includes opposed substantially flat front and back walls with opposed gusseted sidewalls. These walls are joined at corners formed by folding or creasing the material that forms sidewall 112.

Bag 110 may be fabricated from the same materials as bag 10 described above.

Sidewall 112 includes first 116 and second 118 longitudinal edges that are joined together in an overlap seam 120 to form continuous sidewall 112 in the shape of a tube that forms the majority of bag 110. In the second embodiment of the invention, seam 120 is centrally positioned with respect to one of the walls of bag 110. In the exemplary rectangular embodiment, seam 120 is disposed in the center of one of the short walls as depicted in FIG. 8. In other embodiments of the invention, seam 120 may be offset with respect to center if such offset is desired.

Bottom wall 114 is formed from the same tube of material that is used to form sidewall 112. This tube is folded to form bottom wall 114 with the ends of the tube being overlapped and welded onto themselves to form a flat seam 122 such that wall 114 is free of a projecting seam. The folding process creates gussets 124 that allow bag 110 to be folded flat. The configuration of these gussets and the general manner of folding them is known to those skilled in the art and the specific folds are not described in detail in this specification. When bottom wall 114 is folded, seam 120 extends across a portion of bottom wall 114. Bottom wall 114 is thus flat and allows bag 110 to stand up in an open configuration as depicted in FIG. 6 so that bag 110 may be used in the manners described in the Background of the Invention section of this specification. In known prior art bags, the end of the tube used to form the bag would form a projecting flap when the edges of the tube are welded together. Such a projecting flap would hinder the bag from standing upright. The invention overcomes this drawback in prior art bags.

Either of bags 10 or 110 may be fabricated according to the following method. The method is described for bag 10 with it being understood by those skilled in the art that bag 110 may be fabricated by the same or an equivalent method.

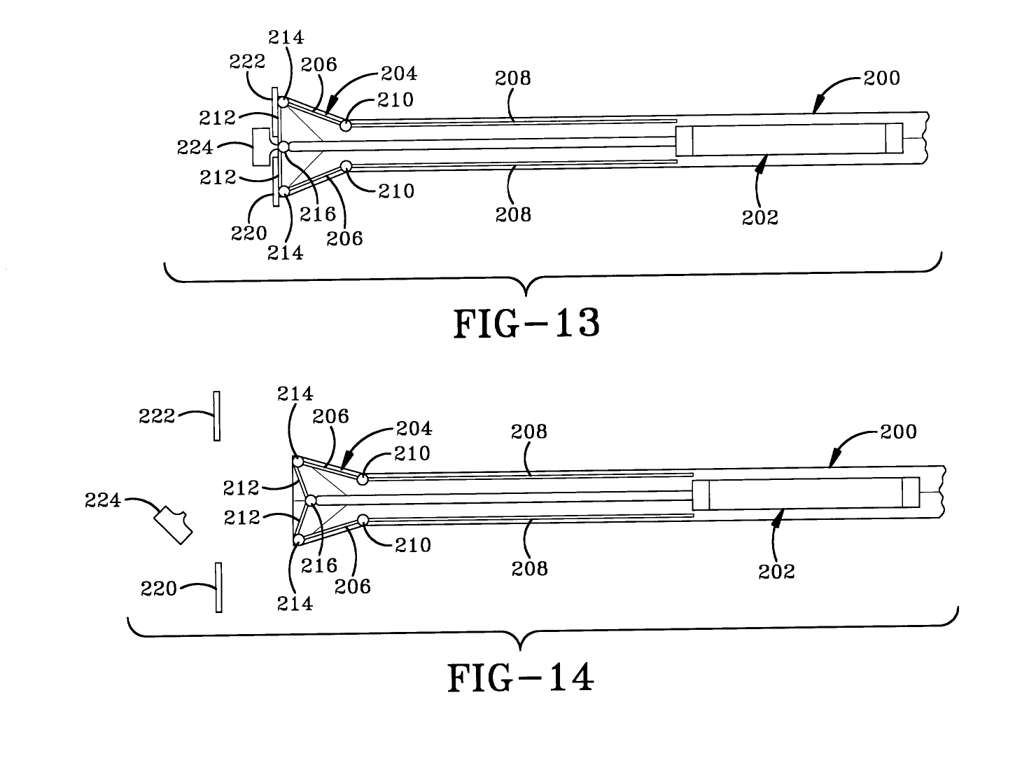

A sheet of material that will form bag 10 or 110 is first drawn into a tube 200 such that the longitudinal edges 16 and 18 of tube 200 may be overlapped and welded together to form seam 20. The apparatus that is used to form tube 200 is known to those skilled in the art. This apparatus bends a flat sheet of material into a tube such that the edges are adjacent. The flat sheet of material may be stored in a large roll if desired. The creases that form gussets 24 and the corners of bag 10 are formed into the material the forms the tube before tube 200 is formed or immediately after tube 200 is formed. In the exemplary embodiment of this step depicted in FIG. 11, tube 200 is partially collapsed as it is moved over an actuator 202 such as an air cylinder or a linear actuator. In other embodiments of the invention, tube 200 may be passed over actuator 202 in an expanded condition.

A former 204 is connected to the movable element 206 of actuator 202. Former 204 is positioned downstream of actuator 202 such that the material of tube 200 passes over the body of actuator 202 before it reaches former 204. In one embodiment of the invention, former 204 is capable of being expanded from a collapsed position (FIG. 11) to an expanded position (FIG. 13) by actuating actuator 202 from a retracted position to an extended position.

Former 204 includes two outer links 206 that are pivotally connected to a fixed frame 208 at a first pivot 210. Frame 208 may be connected to actuator 202 or the same supports that support actuator 202. Frame 208 may be used to help guide tube 200. Former 204 further includes a pair of bottom former plates 212 that are pivotally connected to outer links at second pivots 214. The inner ends of bottom former plates 212 are pivotally connected together at a third pivot 216. The extendable and retractable portion of actuator 202 is also connected to former plates 212 so that plates 212 may be moved between the collapsed position depicted in FIG. 11 and the forming position depicted in FIG. 13. In the embodiment of the invention depicted in the drawings, actuator 202 is connected to third pivot 216.

The apparatus for forming bag 10 further includes first 220 and second 222 overlap and clamp plates and a welder 224. The apparatus also includes a cutter that severs tube 200 as is known in the art of bag forming.

The method for forming bag 10 includes the step of forming tube 200 and moving tube 200 over former 204. Tube 200 may be moved with appropriate mechanisms known to those skilled in the art. When tube is initially moved over former 204, former 204 is in the collapsed position. Tube 200 is moved over former 204 until enough material to form bottom wall 14 extends beyond second pivots 214.

At this point, actuator 202 is moved from the retracted position to the extended position. As actuator 202 is extended, overlap and clamp plates 220 and 222 are moved into position as shown in FIG. 12. Plates 220 and 222 engage the portion of tube 200 that extends beyond second pivots 214 to start folding the material into bottom wall 14. As actuator 202 extends, former 204 moves toward the expanded position with bottom former plates 212 pushing outer links 206 outwardly about first pivots 210. As these elements move in FIG. 12, welder 224 moves into position.

The movement of overlap and clamp plates 220 and 222 is coordinated so that plates 220 and 222 arrive at their clamping position just after bottom former plates 212 reach the expanded position as shown in FIG. 13. Plates 212, 220, and 222 cooperated to clamp bottom wall 14 in place with the leading edge of tube 200 being overlapped to form seam 22. The overlap is formed by the movement of plates 220 and 222. Once plates 220 and 222 are in position, welder 224 heats seam 22 until the material is welded into a flat, non-protruding seam as described above.

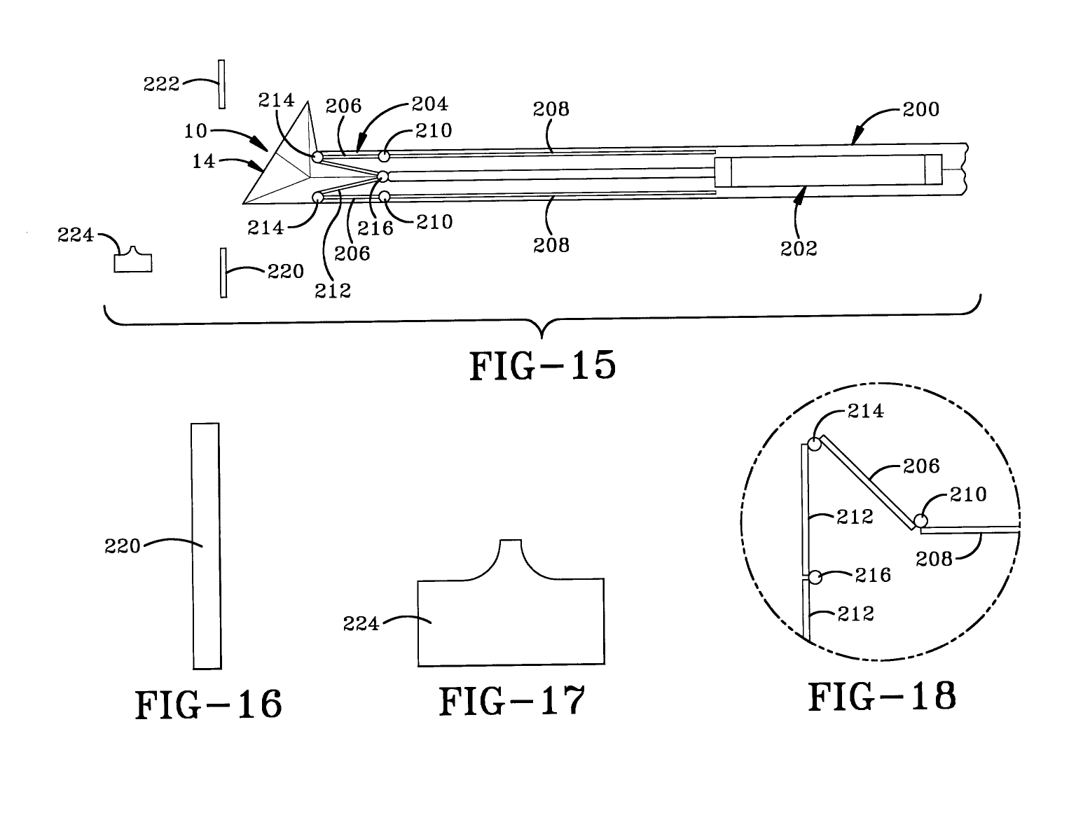

Once seam 22 is welded, plates 220 and 222 as well as welder 224 are removed as shown in FIG. 14. At this time, former 204 is collapsed by retracting actuator 202. As former 204 collapses, the end of bag 10 folds up as shown in FIG. 15 so that bag 10 will be in a flat condition after it is formed. Tube 200 continues to move over former 204 until sidewall 12 reaches a desired length. The cutter then severs tube 200 to form bag 10. The process is then repeated for the next bag 10.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A flat bottom, stand-up bag comprising:
a body having a sidewall and a bottom wall;
the sidewall and bottom wall cooperating to define a storage compartment;
the sidewall having a longitudinal direction disposed along the length of the sidewall;
the body being formed from a section of material having overlapped edges connected together in a first flat seam;
the first flat seam being disposed in the longitudinal direction along the sidewall;
the first flat seam extending from the sidewall to the bottom wall; and
the bottom wall being flat and free of protruding flaps.

2. The bag of claim 1, wherein the sidewall is continuous.

3. The bag of claim 1, wherein the material is weldable.

4. The bag of claim 3, wherein the material is one of a plastic, metal, and blown film.

5. The bag of claim 4, wherein the blown film is mono layer.

6. The bag of claim 3, wherein the material is a multi layer material.

7. The bag of claim 1, wherein the first flat seam extends across a portion of the bottom wall.

8. The bag of claim 1, wherein the sidewall is tube-shaped in cross section when viewed in a direction normal to the bottom wall.

9. The bag of claim 8, wherein the sidewall has a rectangular cross section when viewed in a direction normal to the bottom wall.

10. The bag of claim 1, wherein the sidewall defines opposed front and back walls connected by opposed sidewalls.

11. The bag of claim 10, wherein the opposed sidewalls are gusseted.

12. The bag of claim 10, wherein the first flat seam is disposed in the middle of one of the sidewalls.

13. The bag of claim 10, wherein the first flat seam is disposed in the middle of one of the front and back walls.

14. The bag of claim 1, wherein the body is fabricated from a tube having an end wall; the end wall being overlapped to form a second flat seam at the bottom wall.

15. The bag of claim 14, wherein the second seam is welded.

16. The bag of claim 15, wherein the second seam extends across the bottom wall.

17. A flat bottom, stand-up bag comprising:
a body having a sidewall and a bottom wall;
the body being formed from a tube of material having overlapped longitudinal edges and an end;
the sidewall and bottom wall cooperating to define a storage compartment;
the sidewall having a longitudinal direction disposed along the length of the sidewall;
the overlapped edges being disposed in the longitudinal direction along the sidewall to form a first flat seam; and
the end of the tube being overlapped and flat to form a portion of the bottom wall.

18. The bag of claim 17, wherein the overlapped end of the tube is welded.

19. The bag of claim 18, wherein the sidewall and bottom wall is formed from a single section of material.

20. A method for forming a flat bottom, stand up bag having a bottom wall and a sidewall; the method comprising the steps of:
(a) providing a tube of weldable material having an end;
(b) moving at least a portion of the tube over a collapsed former that is movable between collapsed and expanded positions;
(c) expanding the former from the collapsed position to the expanded position after step (b); and
(d) welding the end of the tube together to form a flat seam that forms a portion of the bottom of the bag.

21. The method of claim 20, further comprising the step of forming the tube of material by drawing the tube from a sheet of material having opposed longitudinal edges.

22. The method of claim 21, further comprising the step of overlapping the opposed longitudinal edges to form a longitudinal flat seam.

23. The method of claim 22, further comprising the step of welding the overlapped opposed longitudinal edges to form the longitudinal flat seam.

24. The method of claim 20, further comprising the step of moving the tube over a linear actuator that is connected to the former.

25. The method of claim 20, wherein step (d) includes the step of clamping a portion of the tube of weldable material between clamp plates and the former such that the end of the tube is overlapped with itself.

26. The method of claim 25, further comprising the step of spacing the clamp plates apart with the overlapped end of the tube positioned intermediate the clamp plates.

27. An apparatus for performing the steps of claim 20.

28. The apparatus of claim 27, wherein the former includes a plurality of links that pivot with respect to each other.

29. The apparatus of claim 28, wherein the former is connected to a linear actuator movable between retracted and extended positions.
